(19) United States
(12) Patent Application Publication
(10) Pub. No.: US 2016/0063436 A1
(43) Pub. Date: Mar. 3, 2016

(54) OPTIMAL BUNDLING OF ROUTES IN A COURIER MARKETPLACE

(71) Applicants: Peter Andrew Coles, San Jose, CA (US); Kane Sweeney, San Francisco, CA (US)

(72) Inventors: Peter Andrew Coles, San Jose, CA (US); Kane Sweeney, San Francisco, CA (US)

(21) Appl. No.: 14/473,057

(22) Filed: Aug. 29, 2014

(51) Int. Cl. G06Q 10/08

(52) U.S. Cl. CPC G06Q 10/08345; G06Q 10/08355

(57) ABSTRACT

A first delivery job is received and placed into a queue to be auctioned to couriers after a first period of time that is determined based on first delivery constraints of the first job. A second delivery job is received before the first period of time expires. The second job is placed into the queue to be auctioned after a second period of time that is determined based on second delivery constraints of the second job if it is determined that the first and second jobs cannot be performed by a single courier within the delivery constraints of both jobs. The jobs are auctioned to couriers as a single item after a third period of time that is determined based on the delivery constraints of both jobs if the first and second jobs may be performed by a single courier within the delivery constraints of both jobs.

### TECHNICAL FIELD

This application relates generally to the field of computer technology and, in specific example embodiments, to methods and systems for optimizing bundling of routes in a courier marketplace.

### BACKGROUND

A point-to-point distribution system may include vehicles traveling directly to a destination, as opposed to going through a central hub before arriving at their final destination. A point-to-point courier based delivery system may therefore provide fast delivery times but often does so at high costs. A hub-and-spoke distribution system may include connections arranged in a wheel like formation, such that traffic moves along spokes of the wheel connected to the hub at the center of the wheel. A hub-and-spoke model may provide slower delivery times than a point-to-point system but often does so at lower costs.

Auctioning delivery jobs to couriers may include a reverse auction in which roles of buyer and seller are reversed. In a typical auction, a seller offers an item for sale and potential buyers then bid on the item for an established period of time (or until another termination criteria has been met), and the potential buyer with a highest bid wins the right to purchase the item. A reverse auction is different in that a buyer offers a contract (e.g., delivery job) out for bidding (e.g., via an online marketplace), and potential sellers then bid on the contract for an established period of time. As a reverse auction progresses, the price of the contract decreases as potential sellers compete to offer lower bids while still meeting all of the specifications of the original contract.

Multiple delivery jobs may be auctioned to couriers via a “combinatorial auction” in which the bidders may place bids for combinations of items instead of only one individual item. For example, if an auctioneer wishes to maximize the value obtained from the auction of properties A, B, C, and D, the auctioneer may want to leverage the fact that bidders may have a willingness to exchange more value for combinations of properties than they would for individual elements of the combination, if considered alone and aggregated. However, determining which synergies are present among items to be listed in a combinatorial auction or determining how to combine items for listing at auction in a way that maximizes the auctioneer's revenue is non-trivial.

### BRIEF DESCRIPTION OF THE DRAWINGS

The present disclosure is illustrated by way of example, and not by way of limitation, in the figures of the accompanying drawings in which:

FIG. 1 is a network diagram depicting a network environment having a client-server architecture configured for exchanging data over a network, according to one embodiment.

FIG. 2 shows a block diagram illustrating one example embodiment of a marketplace application.

FIG. 3 shows a block diagram illustrating one example embodiment of a courier marketplace application.

FIG. 4 shows a map diagram illustrating one example embodiment of calculated routes used to determine a grouping of jobs for auction using the courier marketplace application.

FIG. 5 shows a flow diagram illustrating one example embodiment of an operation of the courier marketplace application.

FIG. 6 shows a flow diagram illustrating one example embodiment of a method for grouping jobs for auction to couriers as a single item.

FIG. 7 shows a flow diagram illustrating one example embodiment of a method for determining that a delivery job or group of delivery jobs should be placed in a queue or listed for auction to couriers.

FIG. 8 shows a ladder diagram illustrating one example embodiment of a method for grouping delivery jobs for auction on the courier marketplace application.

FIG. 9 shows a diagrammatic representation of machine, in the example form of a computer system, within which a set of instructions may be executed to cause the machine to perform any one or more of the methodologies discussed herein.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

In an example embodiment, bundling of package delivery jobs in order to maximize synergies that may increase a value of the jobs that are bundled together occurs in the context of a distributed courier marketplace. Individual delivery orders may come in over time, and packages may be delivered according to specified delivery constraints. In this context, packages may be delivered by a fleet of small vehicles using an algorithm for bundling small numbers of routes together on a dynamic, on-the-fly basis, where bundles are chosen to maximize efficiency while respecting the capacities of vehicles that may be used for the deliveries. Operating with vehicles that deliver only a small number of packages on each route may allow a delivery time to be as fast as delivery times in a point-to-point single delivery job auction system like Shutl Marketplace (developed by Shutl of London, England).

In an example embodiment, bundling jobs for auction may help to reduce the cost of deliveries in comparison to high per-delivery costs associated with a point-to-point single delivery job auction system. The costs savings may come from multiple sources of increased efficiency. Firstly, jobs may be bundled so that the order of the pickup and drop-off locations minimizes a distance traveled by couriers or time it takes for a couriers to complete the delivery jobs. Secondly, jobs may be bundled so that the couriers drive certain stretches with more than one package in their vehicle, which reduces redundancy found in a point-to-point system and further reduces total distance driven or time elapsed. Thirdly, jobs may be bundled so that a total distance (or time to traverse the distance) drivers will cover to begin a route (e.g., distance from courier's actual location to first pickup location) may be minimized. In a point-to-point delivery job auction model, the cost of traversing this initial distance, along with any fixed costs associated with instantiating a route such as fixed pickup and drop-off costs, are incurred for each delivery, and therefore these costs may be reduced in a setting with fewer total routes for delivering the packages associated with the bundled delivery jobs.

Systems and methods for the optimal grouping or bundling of routes for auction to couriers as a single item are described. The system identifies a first delivery job received from a buyer of an offering on an online merchant marketplace. The purchased offering may comprise a package physically held at a seller fulfillment center such as a warehouse. The first job includes information including a pickup location specified by the seller (e.g., fulfillment center), a drop-off location specified by the buyer (e.g., buyer's home) and delivery constraints such as, for example, a deliver by date or a preferred courier. The system identifies a first period of time during which the first job may be placed in a queue based on the delivery constraints associated with the first job or other relevant data. After this first period of time the first job may be forwarded to an online courier marketplace where couriers may bid on the first job to perform the delivery of the package associated with the first job.

Alternatively, while the first job is in the queue the system may receive a second job for delivery of a second package from a second pickup location to a second drop-off location. The second job also includes an associated set of delivery constraints. If the system determines that that the first and second jobs may not be performed cost effectively by a single courier within the delivery constraints of both jobs, the second job may be placed into the queue for a second period of time that is determined based on the second delivery constraints. After this second period of time, the second job may be listed on the online marketplace for auction to couriers. If the system determines that the first and second jobs may be performed cost effectively by a single courier within the delivery constraints of both jobs, the first and second jobs are listed on the online marketplace for auction to couriers as a single item after a third period of time that is determined based on the delivery constraints of both jobs.

Bidding may be performed in real-time (e.g., via the Internet) so as to achieve a dynamic, competitive process. The contract to fulfil the job may be awarded to the seller who bid the lowest price or may be awarded depending on constraints associated with the job in regard to quality, lead-time, capacity, or other value-adding capabilities. The system determines whether the courier can fulfill the delivery job based on an identification of the package to be delivered and the capabilities of the courier.

In one embodiment, the determination that the first and second job may be performed cost effectively by a single courier includes determining that the first and second packages may be delivered along a single route at less cost than the first and second packages may be delivered along respective first and second routes.

In an embodiment, the cost of a route is measured as a function of the distance a courier must travel to traverse the route or the time it takes for a courier to traverse the route.

In an embodiment, the cost of a route is measured as a function of a number of distinct pickup locations and a number of distinct drop-off locations along the route.

In an embodiment, the system receives a third job for delivery before the third period of time expires, the third job being for delivery of a third package from a third pickup location to a third drop-off location, and the third job including third delivery constraints. The system may then place the third job into the queue for a fourth period of time that is determined based on the third delivery constraints and based on determining that the third job may not be performed together with at least one of the first or second jobs cost effectively by a single courier within the delivery constraints of the jobs to be performed together. After the fourth period of time expires the system may list the third job on the online marketplace for auction to couriers.

In an embodiment, the system may compute the bundles of jobs that result in the lowest combined cost of routes for delivery of all the packages within the respective delivery constraints of the jobs based on determining that the third job may be performed together with at least one of the first or second jobs cost effectively by a single courier within the respective delivery constraints of the jobs to be performed together. The system may then list a particular bundle that may be performed cost effectively by a single courier within the respective delivery constraints of the jobs in the particular bundle on the courier marketplace (for auction to couriers) after a fifth period of time that is determined based on the delivery constraints of the jobs in the particular bundle.

In another embodiment, the system may list the particular bundle on the online marketplace for auction to couriers based on determining that no new job for delivery of an additional package is likely to be received before the fifth period of time expires wherein the new job may be performed together with the jobs of the particular bundle cost effectively by a single courier within the respective delivery constraints of the jobs to be performed together.

In another embodiment, the system may determine that no new job for delivery of an additional package that may be performed together with the jobs of the particular bundle is likely to be received. The determination may include processing historical data regarding at least one of the rate at which jobs are received or the likelihood of receiving a job with an associated pickup or drop-off location that is within a threshold distance from any of the pickup or drop-off locations associated with other jobs in the queue before each of their respective associated time periods expires.

In an embodiment, the bundling of package delivery jobs occurs in the context of a distributed courier marketplace. Individual orders may come in over time and packages may be delivered according to specified delivery constraints.

In an embodiment, a method for optimally choosing small bundles includes a batch model and a dynamic model. In the batch model, it may be assumed that deliveries will be made by a fleet of capacity-constrained small vehicles, but that all pickup and drop-off locations are known in advance of computing optimal bundles of jobs. Deliveries are to be made in a fixed time frame (e.g., delivery constraints), and hence may be optimized as a “batch.” In the dynamic model, orders arrive over time, and bundles need to be assigned on the fly. In one version of the dynamic model, customers may request a particular timeframe for delivery (e.g., delivery constraints), and a simple extension of the batch model (e.g., all pickup and drop-off locations are known in advance of computing optimal bundles of jobs) may be applied to each potential delivery time frame, In another version of the dynamic model, packages are assumed to be delivered on a same-day basis, and the bundles are determined on-the-fly in a more flexible manner than in the batch mode.

### System Architecture

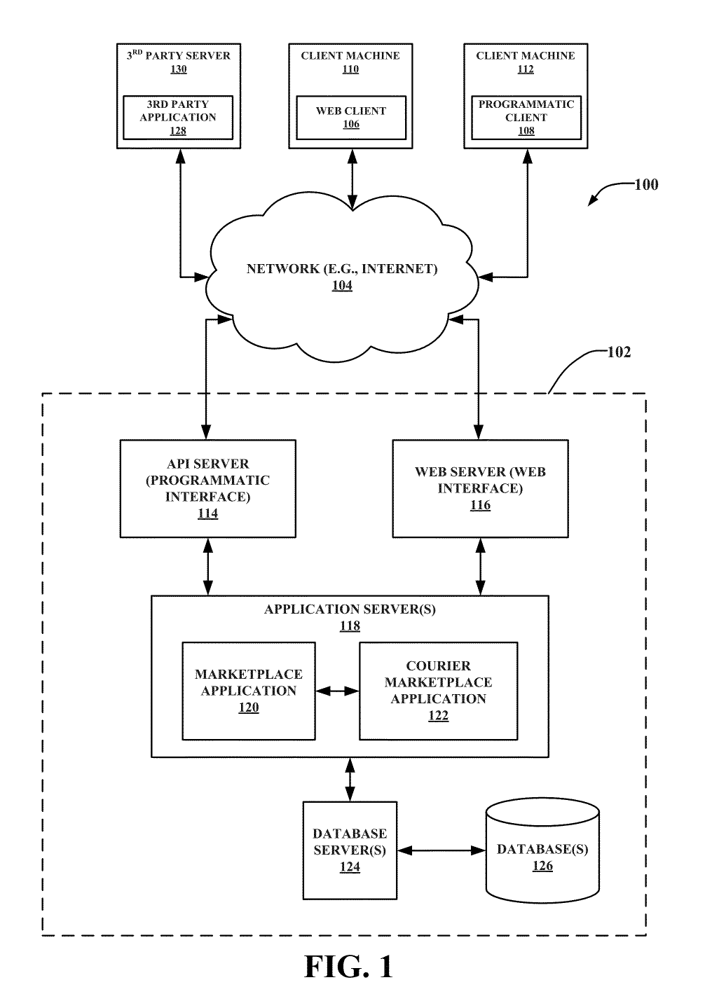

FIG. 1 is a network diagram depicting a network environment 100 having a client-server architecture configured for exchanging data over a network, according to one embodiment. For example, the network environment 100 may include a publication/publisher functionality where clients may communicate and exchange data within the network environment 100. The data may pertain to various functions (e.g., online item purchases) and aspects (e.g., managing content and/or scheduling deliveries of purchased items) associated with the network environment 100 and its users. Although illustrated herein as including a client-server architecture, other embodiments may include other network architectures, such as peer-to-peer or distributed network environments.

A data exchange platform, in an example form of a marketplace application 120 (e.g., eBay Inc. of San Jose, Calif.) and a courier marketplace application 122 (e.g., Shutl Marketplace of London, England), may provide server-side functionality, via a network 104 (e.g., the Internet) to one or more clients. The one or more clients may include users (e.g., buyers and sellers) that utilize the marketplace application 120, and users (e.g., couriers) that utilize the courier marketplace application 122 to exchange data over the network 104. These transactions may include transmitting, receiving (communicating), and processing data to, from, and regarding content and users of the network environment 100. The data may include, but is not limited to, content and user data such as user profiles; user attributes; product and service reviews and information, such as pricing and descriptive information; product, service, manufacturer, and vendor recommendations and modules; product and service listings associated with buyers, sellers or couriers; auction bids; and transaction data, such as collection and payment, shipping transactions, shipping label purchases, and real time synchronization of financial journals, among others.

In various embodiments, the data exchanges within the network environment 100 may be dependent upon user-selected functions available through one or more client or user interfaces (UIs). The UIs may be associated with a client machine, such as a client machine 110 using a web client 106. The web client 106 may, for example, be in communication with the marketplace application 120 via a web server 116. The UIs may also be associated with a client machine 112 using a programmatic client 108, such as a client application, or a third party server 130 with a third party application 128. It will be appreciated that in various embodiments, the client machines 110, 112, or third party server 130 may be associated with a buyer, a seller, a third party electronic commerce platform, a payment service provider, a shipping service provider (e.g., a courier), or a financial institution system, each in communication with the networked system 102 and optionally with each other. The buyers, sellers, and couriers may be any one of individuals, merchants, or service providers.

Turning specifically to the marketplace application 120 and the courier marketplace application 122, an application program interface (API) server 114 and the web server 116 are coupled to, and provide programmatic and web interfaces respectively to, one or more application servers 118. The application servers 118 host a marketplace applications 120 and courier marketplace application 122. The application servers 118 are, in turn, shown to be coupled to one or more database servers 124 that facilitate access to one or more databases 126 which may include information such as user profiles (e.g., for buyers, sellers, and couriers), map data, historical job data, historical bidding data, etc.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods or services (e.g., for sale) published on the marketplace application 120.

In one embodiment, the courier marketplace application 122 includes a system and a method for optimization of the bundling of delivery jobs into a single item for auction to users.

For example, warehouses or seller fulfillment centers may include physical facilities located throughout one or more geographic regions configured to hold inventory for sellers so that a seller may ship an item sold to a buyer on the marketplace application 120 from a pickup location that is a fulfillment center of the seller that is closest to a drop-off location associated with the buyer. The pickup location may also be a home address in a peer-to-peer transaction. Once the item is sold using the marketplace application 120, the delivery job may then be fulfilled by shipping a package including the purchased item from the fulfillment center pickup location specified by the seller or associated with the seller's profile to the drop-off location specified by the buyer or associated with the buyer's profile. As such, the marketplace application 120 may forward details of such a purchase transaction between users of the system 102 to the courier marketplace application 122 which may, alternatively keep track of an inventory of items in the network of the seller fulfillment centers associated with user-sellers of the system 102. Furthermore, additional data may be accessed by the courier marketplace application 122 from historical data of the marketplace application 120 to determine, for example, package details (e.g., descriptions, dimensions, weights, shipping services) most often used or associated with, cost of service, frequency of jobs received for each geographic region, and estimated delivery time.

The courier marketplace application 122 may list a first package delivery job associated with a first purchase transaction, for which associated information has been received from the marketplace application 120, for auction to users providing delivery services (e.g., couriers) once the information is received. Alternatively, the courier marketplace application 122 may identify a first period of time during which the first job may be placed in a queue without violating any of the delivery constraints associated with the first job (e.g., first delivery constraints). The courier marketplace application 122 may then wait for more jobs to be received so that multiple package delivery jobs may be combined for shipment of the associated packages by a single courier so that the shipping cost per package may be reduced as a result of the combination. The period of time that the first job may remain in the queue before being listed by the online courier marketplace (where couriers may bid on the job to deliver the first package) may be computed based on the delivery constraints or other relevant data.

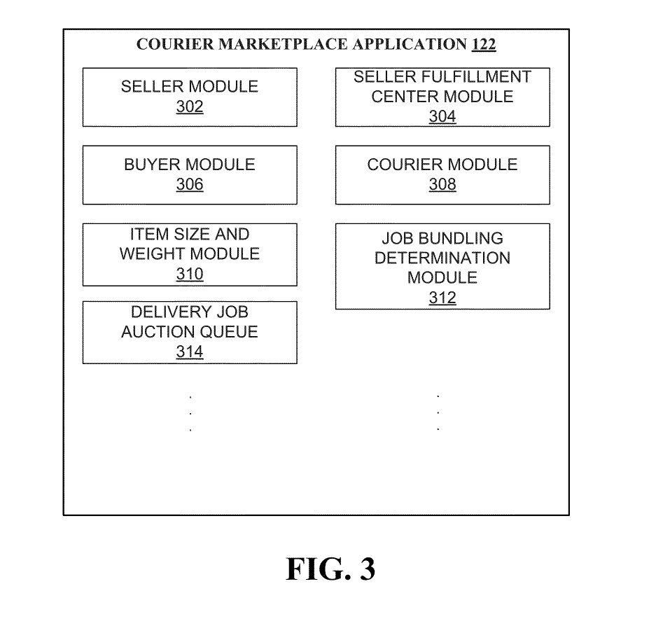

While the first received job is in the queue the marketplace application 120 may process a second purchase transaction between users including a second job for delivery of a second package from a second pickup location to a second drop-off location. The relevant information associated with the second purchase transaction may be forwarded to courier marketplace application 122. The second job may also include an associated set of delivery constraints. If the courier marketplace application 122 determines that the first and second jobs may not be performed cost effectively by a single courier (e.g., at less cost than multiple couriers) within the delivery constraints of both jobs, the second job may be placed into the queue for a second period of time that is determined based on the second delivery constraints. After this second period of time, the second job may be listed by the courier marketplace application 122 for auction to couriers. However, if the courier marketplace application 122 determines that the first and second jobs may be performed cost effectively by a single courier within the delivery constraints of both jobs, the first and second jobs may be listed by the courier marketplace application 122 for auction to couriers as a single item after a third period of time that is determined based on the delivery constraints of both jobs. The courier marketplace application 122 is described in detail below with respect to FIG. 3.

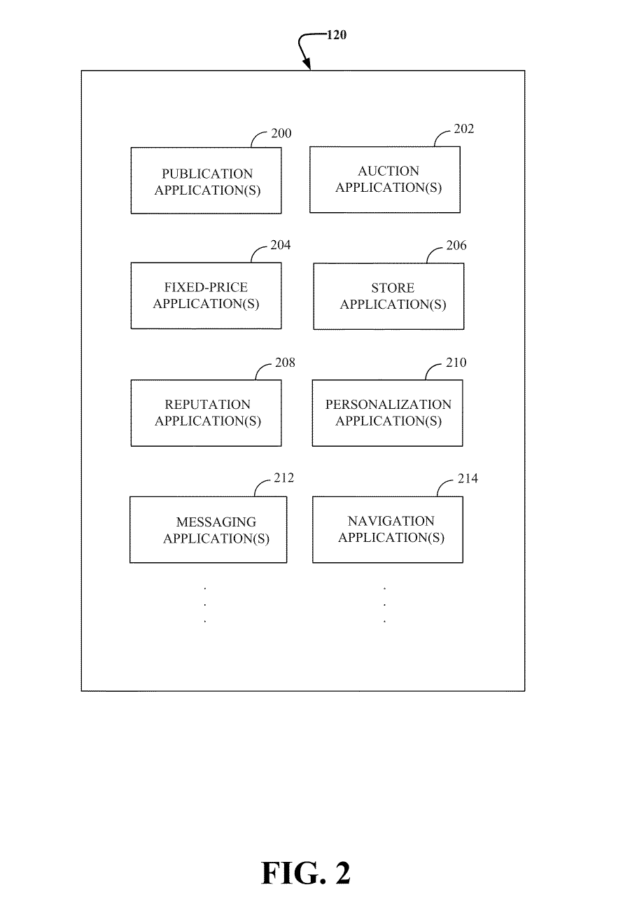

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the courier marketplace application 122 themselves are communicatively coupled (e.g., via appropriate interfaces) to each other and to various data sources, so as to allow information (e.g., regarding jobs for delivery of packages) to be passed between the marketplace application 120 and the courier marketplace application 122 or so as to allow the marketplace application 120 and the courier marketplace application 122 to share and access common data. The marketplace application 120 and the courier marketplace application 122 may, furthermore, access one or more databases 126 via the database server(s) 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include several applications, for example, at least one publication application 200 and one or more auction applications 202, which support auction-format listing and price setting mechanisms (e.g., English, Dutch, Vickrey, Chinese, Double, Reverse auctions). The various auction applications 202 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

Messaging applications 212 are responsible for the generation and delivery of messages to users of the networked system 102 (e.g., messages advising users regarding the status of listings at the networked system 102 (e.g., providing “outbid” notices to bidders during an auction process or to provide promotional and merchandising information to users)). Respective messaging applications 212 may utilize any one of a number of message delivery networks and platforms to deliver messages to users. For example, messaging applications 212 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

FIG. 3 shows a block diagram illustrating one example embodiment of the courier marketplace application 122. The courier marketplace application 122 may include a seller module 302, a seller fulfillment center module 304, a buyer module 306, a courier module 308, an item size and weight module 310, a job bundling determination module 312, and a delivery job auction queue 314.

Once an item is sold using the marketplace application 120, a delivery job may be fulfilled by shipping a package including the purchased item from a pickup location specified by the seller or associated with the seller's profile to the drop-off location specified by the buyer or associated with the buyer's profile. The marketplace application 120 may forward the details of a first purchase transaction between users (e.g., buyer and seller) to the courier marketplace application 122 as a job to be auctioned to users providing transportation services (e.g., couriers). The details of the transaction may include specified pickup and drop-off locations and delivery constraints associated with the transaction. Furthermore, the courier marketplace application 122 may keep track of the inventory of items in a network of seller fulfillment centers associated with users of the system 102. Additional data may be mined by the courier marketplace application 122 from the historical data of the marketplace application 120 to determine, for example, package details like descriptions, dimensions, weights, shipping services most often used or associated with, cost of service, frequency of jobs received for each geographic region, and estimated delivery time. This data may be stored or accessed via the database server(s) 124 and the databases(s) 126.

For example, warehouses or seller fulfillment centers may include physical facilities located throughout one or more geographic regions. The warehouses or seller fulfillment centers are configured to hold inventory for sellers so that a seller may ship an item sold to a buyer on the marketplace application 120 from a pickup location that is a fulfillment center of the seller that is closest to the drop-off location associated with the buyer.

The seller module 302 may identify a pickup location associated with the seller or other relevant data associated with the seller (e.g., seller profile). For example, the location may be a residence location of the seller, work location of the seller, or any other location specified by the seller where the item is to be shipped from by the seller. The seller may include a user who listed an item for sale using the marketplace application 120. The term “seller” may also refer to a user who has sold or not yet sold a listed item for sale in the marketplace application 120. The seller module 302 may communicate with the marketplace application 120 to access location information of the seller. Alternative, this data may also be stored or accessed via the database server(s) 124 and the databases(s) 126.

The seller fulfillment center module 304 identifies a fulfillment center associated with a region of the location of the seller identified by the seller location module 302. The region may include a geographic region such as a zip code area, a county, a city, etc. In one embodiment, the seller fulfillment center module 304 identifies one or more fulfillment centers from a network of fulfillment centers of the marketplace application 120 closest to the location of the buyer. The seller fulfillment center module 304 may then select a fulfillment center from the identified fulfillment centers closest to the buyer based on the capacities of the fulfillment center. Capacities may include physical space, available space, strategic geographic area, manpower, ease of access to shipping carriers, etc. In one embodiment, the seller fulfillment center module 304 communicates, via the marketplace application 120, with the seller regarding the location of the selected fulfillment center for the seller to ship the item. The item is then held at the selected fulfillment center until a job from a seller for the item is received in the marketplace application 120. The seller fulfillment center module 304 may communicate with the marketplace application 120 to access fulfillment center location information of the seller. Alternatively, this data may also be stored or accessed via the database server(s) 124 and the databases(s) 126.

The buyer module 306 identifies a location associated with the buyer or other relevant data associated with the buyer (e.g., buyer profile). The location may include the drop-off location where the buyer would like the item delivered. For example, the buyer may identify several locations in the marketplace application 120 for drop-off locations (e.g., home, work, vacation home, etc.). The buyer may also identify a default drop-off location. The buyer may include a user who views an item for sale using the marketplace application 120. The term “buyer” may also refer to a user who has purchased or not yet purchased the item in the marketplace application 120. For example, the user may be referred to as a buyer when the user views items for sale without making a purchase, places any item for sale in a virtual shopping cart or wish list, or purchases any item for sale. The buyer module 306 may communicate with the marketplace application 120 to access location information of the buyer. Alternatively, this data may be stored or accessed via the database server(s) 124 and the databases(s) 126. In another embodiment, the buyer module 306 identifies a buyer geographic region associated with a shipping or drop-off location of the buyer. For example, the buyer module 306 identifies a county or a zip code associated with the drop-off location of the buyer.

The courier module 308 may identify users providing shipping services (e.g., couriers) corresponding to the pickup and drop-off locations associated with a delivery job. For example, the courier module 308 identifies one or more couriers operating closest to the buyer geographic region using a database or table of couriers and corresponding geographic regions or locations serviced by the couriers. This data may be stored or accessed via database server(s) 124 and the databases(s) 126. In one embodiment, the courier module 308 may identify a courier based on parameters such as distance to the drop-off location of the buyer, ease of access route (e.g., local road vs. highway) to the drop-off location of the buyer, storage capacity of the courier vehicles, speed of courier vehicles, ease of accessibility to shipping carriers, etc. In one embodiment, the courier module 308 may communicate with a courier (e.g., through marketplace application 120) to determine the current capabilities of the courier.

The item size and weight module 310 identifies physical dimensions of the item listed for sale by the seller by accessing historical data of the marketplace application 120. This data may also be stored or accessed via the database server(s) 124 and the databases(s) 126. For example, the item size and weight module 310 can determine how big and how heavy an item is based on an identification of the item and the historical data. In another example, the seller may provide dimensions and weight of the item. In another embodiment, the item size and weight module 310 identifies physical dimensions of a package containing the item listed for sale by the seller using historical data of the marketplace application 120. For example, the item size and weight module 310 can determine or estimate common or typical physical dimensions of a package used to ship the item based on an identification of the item and the historical data.

In one embodiment, the item size and weight module 310 determines whether the item or package is eligible to be shipped using containers of a specified seller fulfillment center. For example, a variety of shipping container or pallet sizes may be available. The item size and weight module 310 may determine that an item is too big for any sizes of the containers. In other words, the seller may not be able ship the item to any fulfillment center for holding because the item may be too large, bulky, or have an odd shape. The item may then be picked up from a location specified by the seller by a courier with the capacity to deliver the item. The capabilities of each courier may be determined using the courier module 308 as described above.

The job bundling determination module 312 may access information regarding prescheduled shipping routes from one seller fulfillment center to another seller fulfillment center. This data may be stored or accessed via the database server(s) 124 and the databases(s) 126, as well as via the seller module 302 or the seller fulfillment center module 304. Prescheduled shipping routes may be established for the network of fulfillment centers. For example, there may be several containers leaving from fulfillment center A to fulfillment center B each day. The containers may leave on a regular interval or have preset schedules. For example, a container may leave at 6 am, 10 am, 2 pm, and 6 pm each day. The preset schedule may also vary based on the date. For example, there may be more containers shipped between the fulfillment center around holidays and less during the weekend. The number of containers and the prescheduled shipping routes may also depend on popular shipping routes. For example, there may be more items for shipping between fulfillment centers between geographic region A and geographic region B than between geographic region A and geographic region C. As such, there may be more containers in transit between geographic region A and geographic region B than between geographic region A and geographic region C. This information may be used by the job bundling determination module 312 to determine pickup and drop-off locations for a delivery job if these are not specified in the purchase transaction information received from marketplace application 120.

The job bundling determination module 312 may further determine which jobs are currently available to be bundled together for auction based on consulting the delivery job auction queue 314 where jobs are placed as they are received. The job bundling determination module 312 may determine how long a job may remain in the queue before being listed for auction based on any delivery constraints specified in the in the purchase transaction information received from the marketplace application 120. Alternatively, the period of time during which a job may remain in the queue before being listed for auction is based on information from the buyer or seller profiles. The job bundling determination module 312 may communicate with the marketplace application 120 to access location information of the buyer. Alternatively, this data may also be stored or accessed via the database server(s) 124 and the databases(s) 126.

Once the courier marketplace application 122 (e.g., via the job bundling determination module 312) has determined that the period of time has expired for a particular job, that job is listed for auction to couriers. If it is determined that the job may be combined or bundled together with other jobs currently in the queue, then the bundled jobs are listed for auction to couriers as a single item so that the bundled jobs may be performed by a single courier along a single route including all of the associated pickup and drop-off locations. By optimally combining jobs for auction, the order of the pickup and drop-off locations may be selected to minimize a distance traveled by couriers or an amount of time it takes for couriers to make deliveries. Furthermore, jobs may be combined so that the couriers may drive certain stretches with more than one package in their vehicle, which reduces redundancy of the point-to-point system and further reduces total distance driven or time elapsed. Further still, jobs may be combined so that the total distance drivers must cover to begin a route (e.g., distance from courier's actual location to first pickup location), along with any fixed costs associated with instantiating a route such as fixed pickup and drop-off costs is minimized.

In one embodiment, the courier marketplace application 122 includes a system and a method for optimization of the bundling of delivery jobs via the job bundling determination module 312 (in communication with the other elements of the courier marketplace application 122 and the networked system 102) for auction to users providing courier services as a single item.

For example, once an item is sold using the marketplace application 120, the details of such a purchase transaction between users of the system 102 may be forwarded to the courier marketplace application 122. The courier marketplace application 122 may receive transaction details such as the buyer, the seller, the purchased item, the pickup address, the drop-off address, and any other delivery constraints such as, for example, a delivery due date. The modules of the courier marketplace application 122 may receive the transaction details relevant to their respective functions and may also communicate with the marketplace application 120 to access further relevant information. The transaction details or other relevant data may also be stored or accessed via the database server(s) 124 and the databases(s) 126. Furthermore, additional data may be accessed by the courier marketplace application 122 from the historical data of the marketplace application 120 to determine, for example, package details such as descriptions, dimensions, weights, shipping services most often used or associated with, cost of service, frequency of jobs received for each geographic region, and estimated delivery time.

The courier marketplace application 122 may list a first package delivery job associated with a first purchase transaction, for which associated information has been received from the marketplace application 120, for auction to users providing delivery services (e.g., couriers) once the information is received. Alternatively, the courier marketplace application 122 (e.g., via the job bundling determination module 312) may identify a first period of time during which the first job may be placed in a queue without violating any of the delivery constraints associated with the first job (e.g., first delivery constraints). The courier marketplace application 122 then waits for more jobs to be received so that multiple package delivery jobs may be combined for shipment of the associated packages by a single courier (e.g., via the job bundling determination module 312). Accordingly, the shipping cost per package may be reduced as a result of the combination. The period of time that the first job may remain in the queue before being listed by the online courier marketplace, where couriers may bid on the job to deliver the first package, may be computed based on the delivery constraints or other relevant data (e.g., as determined via the job bundling determination module 312).

While the first received job is in the queue, the marketplace application 120 may process a second purchase transaction between users including a second job for delivery of a second package from a second pickup location to a second drop-off location. The relevant information associated with the second purchase transaction may be forwarded to courier marketplace application 122. The second job may also include an associated set of delivery constraints (e.g., second delivery constraints). If the courier marketplace application 122 (e.g., via the job bundling determination module 312) determines that that the first and second jobs may not be performed cost effectively by a single courier within the delivery constraints of both jobs, the second job may be placed into the queue for a second period of time that is determined based on the second delivery constraints. After this second period of time, the second job may be listed by the courier marketplace application 122 for auction to couriers. However, if the job bundling determination module 312 determines that the first and second jobs may be performed cost effectively by a single courier within the delivery constraints of both jobs, the first and second jobs may be listed by the courier marketplace application 122 for auction to couriers as a single item after a third period of time as determined by delivery job auction queue 314.

In one embodiment, the determination by the job bundling determination module 312 that the first and second job may be performed cost effectively by a single courier includes determining that the first and second packages may be delivered along a single route at less cost than the first and second packages may be delivered along respective first and second routes. The cost of a route may be measured by the job bundling determination module 312 as a function of the distance a courier must travel to traverse the route or the time it takes for a courier to traverse the route. Alternatively, the cost of a route may be measured by the job bundling determination module 312 as a function of the number of distinct pickup locations and the number of distinct drop-off locations along the route.

In an example embodiment, the courier marketplace application 122 may receive transaction details, regarding a third job for delivery of a third package from a third pickup location to a third drop-off location, before the above-noted third period of time has expired. The third job includes a third set of delivery constraints. The job bundling determination module 312 may place the third job into the queue for a fourth period of time that is determined based on determining that the third job may not be performed together with at least one of the first or second jobs cost effectively by a single courier within the delivery constraints of the jobs. After the fourth period of time expires, the job bundling determination module 312 lists the third job on the online marketplace for auction to couriers.

In an example embodiment, the job bundling determination module 312 may create the bundles of jobs that result in the lowest combined cost of routes for delivery of all the packages within the respective delivery constraints of the jobs based on determining that the third job may be performed together with at least one of the first or second jobs cost effectively by a single courier. The courier marketplace application 122 may list the particular bundle on the online marketplace for auction to couriers after a fifth period of time based on determining that a particular bundle may be performed cost effectively by a single courier within the respective delivery constraints of the jobs in the particular bundle.

In another embodiment, the courier marketplace application 122 may list the particular bundle on the courier marketplace for auction to couriers based on a determination that no new job for delivery of an additional package is likely to be received before the fifth period of time expires, wherein the new job may be performed together with the jobs of the particular bundle cost effectively by a single courier within the respective delivery constraints of the jobs to be performed together.

The job bundling determination module 312 may determine that no new job for delivery of an additional package that may be performed together with the jobs of the particular bundle is likely to be received by processing historical data. The historical data may be related to at least one of: the rate at which jobs are received or the likelihood of receiving a job with an associated pickup or drop-off location that is within a threshold distance limit (or time to traverse limit) from any of the pickup or drop-off locations associated with other jobs in the queue before each of their respective associated time periods expire. The historical data may be received or retrieved from the marketplace application 120 or via the database server(s) 124 and the databases(s) 126.

The following section provides examples of calculations that may be performed by the job bundling determination module 312.

### Concepts

A node vεVåR² is a location in connected set V, the pick-up and delivery regions may be represented by nodes.

A route r=(v₁, . . . , v_{N}) is a vector of nodes.

A job j is a two node route (sⱼ, tⱼ), which may comprise a single pick-up (“from”) and single drop-off (“to”) location.

Route r covers a set of jobs S={(s_{1,}t₁,)(s_{2,}t₂,) . . . , (s_{N,}t_{N})} if:
1. The nodes in r are a permutation of the set of all the nodes in S (so that all packages may be delivered); and
2. e(sᵢ)<e(tᵢ)∀i, where e(·) gives a node's dimensional rank in r (so that pick up of any package may precede the package dropoff).

d:R²→R may be a metric that gives the distance between nodes. This metric may be interpreted as a driving time between any two nodes, or in a simpler analysis may simply be an Euclidian distance.

Route length may then be defined as a total distance to traverse the nodes of route r in order:

$$d ( r ) ≡ {\sum }_{i = 1}^{\vert r \vert - 1} d ( {v}_{i} , {v}_{i + 1} )$$

c_{pick} and c_{drop} may give constant costs of pick-up and drop-off of an item, respectively, and c_{drive} may give the per distance-unit cost of “driving.” Then, total cost c=(c_{pick}, c_{drop}, c_{drive}). In a more expansive model, these costs may depend on package contents, driver, and so forth.

Based on constant costs of pickup and delivery, if the endpoints of all routes in R are distinct, then any bundling arrangement will lead to a constant total cost of pickup and delivery, so the problem reduces to a minimization of distance driven.

The cost of a route r=(v₁, . . . , v_{N}) may be calculated:

$${c}_{pick} \cdot \frac{\vert r \vert}{2} + {c}_{drop} \cdot \frac{\vert r \vert}{2} + {c}_{drive} \cdot {\sum }_{i = 1}^{\vert r \vert - 1} d ( {v}_{i} , {v}_{i + 1} ) ,$$

where it may be assumed that each route comprises 50% pickups and 50% dropoffs.¹ ¹ This may be assumed for routes where each item picked up is actually delivered.

### Batch Bundling

In an example embodiment, all package pick-up and drop-off locations are known beforehand (ex-ante), and all packages need to be delivered within a given timeframe, with no other time constraints (e.g., a full set of jobs is to be optimized as a “batch”). Deliveries are to be bundled or clustered, so that a single courier may handle all pick-ups and deliveries in any single bundle of jobs. Total delivery costs may then be kept as low as possible.

In an example embodiment, by varying the timeframe for bundling the jobs, a bundling determination process may be used in concert with various delivery options a courier firm may offer. For example, if a courier offers “next day delivery,” then all such orders that arrive during a single day are processed at the end of the day and bundled as a batch, to be delivered the following day. The courier may also offer a set of non-overlapping delivery windows. For example, a buyer of an item from a seller may choose a three hour window of time in which the buyer may desire the package to be delivered. In this case, all of the deliveries that are to take place in the particular three window of time may be processed as a batch for optimal bundling of jobs.

### The Optimal Batch Bundling Problem

In an example embodiment, the inputs to an optimal batch bundling problem may include a set J={j₁, . . . , j_{N}} of jobs, cost parameters c, and a capacity constraint on the jobs any one driver may perform. For simplicity, it may be assumed that a driver can take on at most M jobs. Therefore, an output of the problem may be a partition of J into bundles, along with a route associated with each of the bundles.

P(J) denotes a set of all partitions of J. A route set R may cover a partition p of jobs if each job set in p is covered by exactly one route in R. R(p) may be the family of all route sets that cover partition p. Therefore, a set of routes that results in all the jobs in J being completed with no extra stops being made may be defined as:

R(J)≡R(P(J))≡U_{pεP(}J)R₍ₚ₎.

In an example, using the above-noted concepts and notation, an optimal batch bundling problem may be stated as:

$${min}_{R ∈ R ( J )} {\sum }_{r ∈ R} c ( r ) subject to \vert r \vert < M ∀ r .$$

### K-Means Clustering of Jobs

In an example embodiment, an iterative method of assigning jobs to clusters (e.g., bundles) may be a new variant of a standard K-means clustering algorithm (e.g., Lloyd's algorithm) where jobs are being clustered rather than nodes. As noted above, the inputs to a batch bundling problem may be a set J={j₁, . . . , j_{N}} of jobs, cost parameters c, and a capacity constraint Mon the number of jobs any one driver may be able to perform.

The distance between two jobs may be defined by a sum of a distance between the pickup locations and a distance between drop-off locations: i=(sᵢ, tᵢ) and j=(sⱼ, tⱼ) be jobs. Define d(i,j)≡d(sᵢ, sⱼ)+d(tᵢ, tⱼ).

This metric for calculating a distance is based on an assumption that a courier may reasonably pick up several items, drive the “backbone” from a final pickup to a first drop-off, and then drop-off all the items. Since this backbone segment of the route for completing the bundled jobs will need to be driven to make the deliveries, the optimization algorithm may focus on mutual proximity of pickups and mutual proximity of drop-offs.

### The Main Batch Method

In an example, the following method may be used to partition jobs into clusters, and select an optimal route for each cluster.
a. Initialization: Begin with a set S₀ of K jobs, where S₀ ⊂J, and S₀ are randomly chosen;
b. Iterative step x:
   i. Partition J by associating each route jεJ with the element of Sᵢ to which it is closest, according to d(•,•);
   ii. Generate seeds Sₓ₊₁ by taking the centroid of each of K clusters.² In other words, for any cluster, take the centroid of all the sᵢ's and the centroid of all the tᵢ's to generate a new job (not necessarily in J). The set of these K routes define Sₓ₊₁; and ² A centroid of a set of vectors consists of the coordinate by coordinate averages.
iii. If d(Sₓ, Sₓ₊₁) falls below ε(for some specified ε), terminate. Otherwise, increment x and repeat the iterative step;
c. For any cluster that contains more than M jobs, divide this cluster into the two lowest cost subclusters. That is, select the two subclusters that minimize the sum of the lowest cost routes that cover each subcluster; and
d. For each cluster, select the lowest cost route that covers each cluster.

### Handling Multiple Pickup Locations

In some examples, a delivery may have multiple possible pickup locations. For example, if a buyer purchases an item from an online storefront, that item may be delivered from a number of different warehouses or retail spaces operated by the merchant. In these situations, a route may be selected based on efficiently selecting an item's pickup location to keep total delivery costs to a minimum. In this situation the batch method may be performed according to the following example.

In an example, a multi-job: jᵢ^{mult}=({s₁₁, . . . , s₁ₘ},t₁) may pair a set of possible pickup locations with a drop-off location. A bundling method may be adapted to handle input comprising both jobs J and multijobs J^{multi} as follows:
a. In the initialization step: If a multijob is chosen for S₀, select its pickup randomly from its associated set of possible pickup locations; and
b. In the iterative step: When assigning multijob j^{multi} to its nearest cluster, cycle through all j^{multi}'s pickup locations and select that which minimizes a distance to its closest seed.

### Selection of K

In an example embodiment, a lowest cost set of routes that covers job set J may be found by cycling through various choices of K. If the jobs are perfectly distributed so that each cluster contains exactly a maximum number of jobs allowed, M, then there may be J/M clusters. However, in practice, more jobs than this may be needed, so that an assumption may be that K may be set to K=┌J/M┐, and a bundling calculation may be run for each value up to ┌J/M┐.

### Dynamic Bundling

In an example scenario, orders (e.g., jobs) may arrive over time. At each point in time, there may be a set of jobs in a queue, and it may then be determined whether to designate one or more bundles of jobs for delivery (“shipped.”) These bundles may be delivered via an in-house, proprietary fleet, or else may be auctioned in a courier marketplace (e.g., see the following section). Jobs that are not designated for bundling and delivery may remain in the queue. As additional orders arrive, the ship/stay decision may be revisited at each respective point in time.

### General Model

In an example, discrete time periods may be indexed by tεT. Jobs may enter the queue at each time period via an arrival process P. At any time t, a state of an example system may be described by the queue of jobs, along with the length of time each job has been in the queue. For example, when there are N jobs in the queue, a system state a may have the form {(j₁, qⱼ_{₁}), . . . , (j_{N}, qⱼ_{_{N}})} where the q's are the number of periods each job has been in the queue.

In an example, a shipping rule sh(B,a)→{ship, stay} may take as its input a bundle of jobs and a state of a system, and output a decision to either ship the bundle or else let it stay in the queue. A shipping rule may be determined to be feasible if any bundle that is not a subset of the jobs in the state is mapped to “stay” and if for any state, the set of bundles that map to “ship” are non-overlapping.

In an example, such an example system may be expanded to consider costs for the delivery of bundles (as described above), and also expanded to consider a cost of waiting incurred for each job in the queue.

### A Practical Shipping Rule

In an example, a simple shipping rule that efficiently selects which jobs to bundle and ship may be implemented based on an assumption that each job is required to be sent out for shipment after q^{max} time periods. For example:
a. At any state a, begin by bundling the jobs associated with a using a batch method as described above;
b. For each bundle B and associated route r the batch method may examine a per job cost c_{B}≡c(r)/|B|. If c_{B} is below a given threshold c^{max}, then let sh(B,a)=ship;
c. Any job not bundled and shipped that has been in the queue for time q^{max} may be shipped as an individual bundle; and
d. All other jobs may remain in the queue.

The above-noted example shipping rule provides a simple guide for insuring that jobs are only bundled when it is efficient to do so, in that the cost per job drops below a known threshold. Jobs may sit in the queue until the last minute, waiting for complementary jobs with which they may be bundled. This ensures the maximum length of time in which such a system may search for cost-savings via bundling.

### Auctioning Routes

In both the example batch model and the example dynamic model, the selected bundles of jobs may be listed for auction in a courier marketplace. In a simple example, the bundle may be listed as being available for delivery along with an associated price. Couriers may then compete to deliver the bundle. For example, a first courier to accept the bundled jobs may get to perform the bundled delivery jobs. In another example, the bidder with the lowest bid after a specified period of time may get to perform the bundled delivery jobs. In an example, where multiple bidders have submitted equal or nearly equal bids, the winner may be decided based on a reputation of the respective couriers. In a more complex example, couriers may have outstanding bids that are a function of the route length, region, or number of pickups. In this case after a bundle is announced as being ready for delivery, automatic bids for couriers may be calculated, and the winning bidder may perform the bundled delivery jobs.

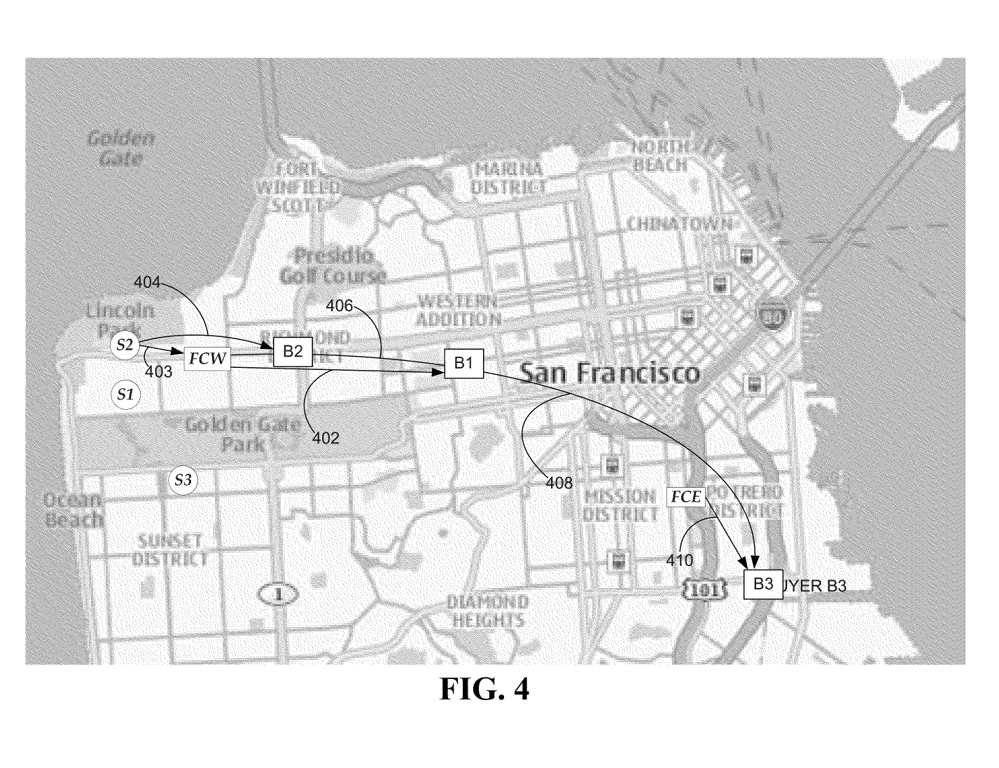

FIG. 4 shows a map diagram illustrating one example embodiment of shipments using the courier marketplace application 122. A first delivery job is received including transaction details such as buyer: B1, seller: S1, pickup location, drop-off location, item to ship, and deliver by date. The first job may be auctioned to couriers for delivery of the item from the pickup location designated by seller S1 (e.g., from the seller fulfillment center FCW) to the drop-off location of buyer B1 shown as a square on the map. However, the first job may instead be placed into a queue in order to wait for more delivery jobs to be received. The period of time that the first job may remain in the queue (e.g., first period of time) before being listed by the online courier marketplace, where couriers may bid on the job to deliver the first package, may be computed based on delivery constraints or other relevant data (e.g., as determined via the job bundling determination module 312 in conjunction with other modules of courier marketplace application 122).

While the first job is in the queue, a second delivery job is received including transaction details such as buyer: B2, seller: S2, pickup location, drop-off location, item to ship, and deliver by date. The second job includes delivery of the item from the pickup location designated by seller S2, shown as a circle on the map, to the drop-off location of buyer B2, also shown as a square on the map. If the courier marketplace application 122 (e.g., via the job bundling determination module 312) determines that the first and second jobs may not be performed cost effectively by a single courier within the delivery constraints of both jobs, the second job may be placed into the queue for a second period of time that is determined based on the second delivery constraints (e.g., as determined via the job bundling determination module 312). After this second period of time, the second job may be listed by the courier marketplace application 122 for auction to couriers. However, if the job bundling determination module 312 determines that the first and second jobs may be performed cost effectively by a single courier within the delivery constraints of both jobs, the first and second jobs may be listed by the courier marketplace application 122 for auction to couriers as a single item after a third period of time, e.g., as determined via the job bundling determination module 312.

In the present example, this determination may specify a determination of a best starting location, which may be one of the two designated pickup locations S2 and FCW. In this case, since the drop-off locations of buyer B1 and B2 are both to the east of both pickup locations, it makes sense to start from a westernmost pickup location S2 and continue on an eastward route to FCW and then on to the drop-off locations of buyers B1 and B2. This route 403+406 (S1→FCW→B2→B1) may be examined to determine if the route 403+406 violates any of the delivery constraints of the first and second delivery jobs. If the route 403+406 is within the relevant delivery constraints, then it may be compared to the individual routes 402 (FCW→B2) and 404 (S2→B2) to determine if the cost of delivering first and second packages by a single courier along route 403+406 is less than the cost of delivering the first and second packages along respective first route 402 and second route 404.

Since, in some embodiments, the cost of a route may be measured by the job bundling determination module 312 as a function of the distance a courier may travel to traverse the route, the distance traveled by a single courier along route 403+406 may be compared to a sum of the distances traveled by two separate couriers along routes 402 and 404.

Alternatively, the cost of a route may be measured by the job bundling determination module 312 as a function of the number of distinct pickup locations and the number of distinct drop-off locations along the route. As such, the number of stops by a single courier along route 403+406 (e.g., 4) may be compared to a sum of the number of stops by two separate couriers along routes 402 and 404 (e.g., 2+2=4).

A third job for delivery of a third package from a third pickup location to a third drop-off location may be received before the above-noted third period of time has expired. The third job includes transaction details such as buyer: B3, seller: S3, drop-off location, item to ship, and deliver by date. The third job does not specify a seller pickup address, and therefore the courier marketplace application 122 may search the relevant database(s) 126 or communicate with marketplace application 120 to determine where the seller may be storing inventory that includes the purchased item and is closest to the drop-off location specified by the buyer B3. In this example, seller fulfillment center FCE is the closest seller inventory location including an instance of the item purchased by buyer B3. Therefore, the third job includes delivery of the item from the pickup location seller fulfillment center FCE to the drop-off location of buyer B3, also shown as a square on the map.

The job bundling determination module 312 may then determine that at least one of the first and second jobs may be performed together with the third job cost effectively by a single courier within the respective delivery constraints of the jobs (e.g., if the purchased item is also present at FCW). By adding stretch 408 to route 403+406, the three jobs may be performed by a single courier traveling along the single combined route 403+406+408. However, since the route 410 is much shorter than the stretch 408, a single courier traveling along route 410 (FCE→B3) would result in a cheaper total cost of combined jobs to deliver all the packages. This is because, if several combinations of the jobs may be performed by a single courier, then the job bundling determination module 312 may determine the combinations of jobs that result in the lowest combined cost of routes for delivery of all the packages within the respective delivery constraints of the jobs included in each combination. In this example, the combined cost of bundling the first two jobs along route 403+406 and delivering the third package along route 410 would be less than the cost of a single courier delivering all three packages along the single combined route 403+406+408.

The courier marketplace application 122 may list each of the combinations for auction to couriers as a single item after a respective period of time that may be determined by the job bundling determination module based on the respective delivery constraints of the jobs in each of the combinations. In this example, the bundled first and second jobs are listed for auction to couriers as a single item after a period of time that is determined based on the first and second delivery constraints, and the third job are listed for auction to couriers after a period of time that is determined based on the third delivery constraints.

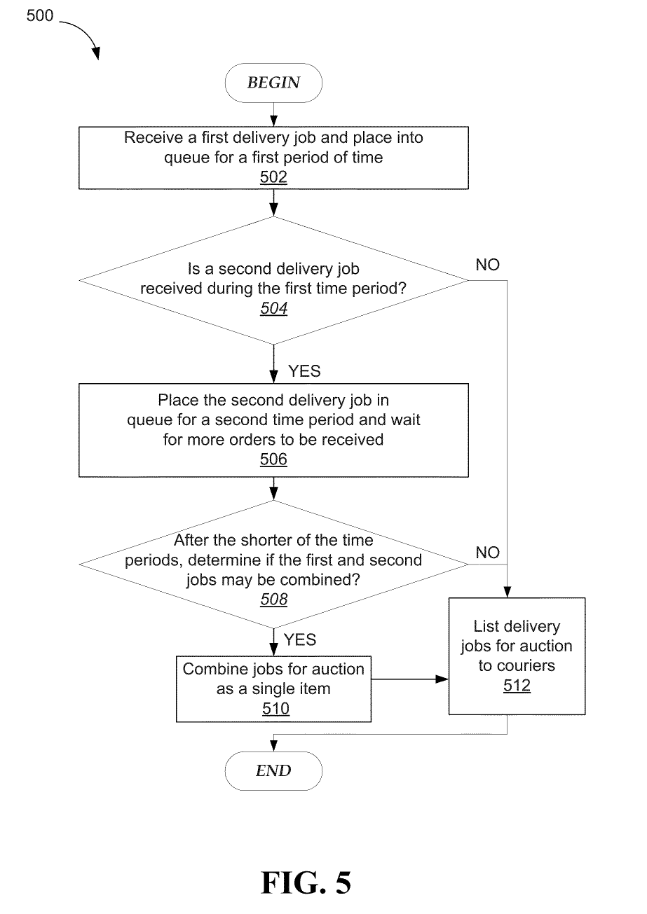

FIG. 5 shows a flow diagram illustrating one example embodiment of a method 500 for the optimal bundling of routes in a courier marketplace.

At operation 502, a first delivery job is received and placed into a queue for a first period of time based on the details of the first job. The first job may be listed for auction to couriers (operation 512) if the first period of time has expired.

At operation 504, if a second delivery job is received before the first period of time has expired, the second job may be placed into the queue for a second period of time based on the details of the second job at operation 506.

After the shorter of the first and second time periods has expired, at operation 508, it is determined if the first and second jobs may be combined so that a single courier may cost effectively deliver both packages without violating any of the constraints included in the details of each delivery job. If not, then the job with the associated time period that is shorter may be listed for auction to couriers immediately, and the other job may remain in the queue for the remainder of its associated time period at operation 512.

If it is determined, at operation 508, that the jobs may be combined then the jobs are bundled for auction as a single item at operation 510, and listed for auction to couriers at operation 512.

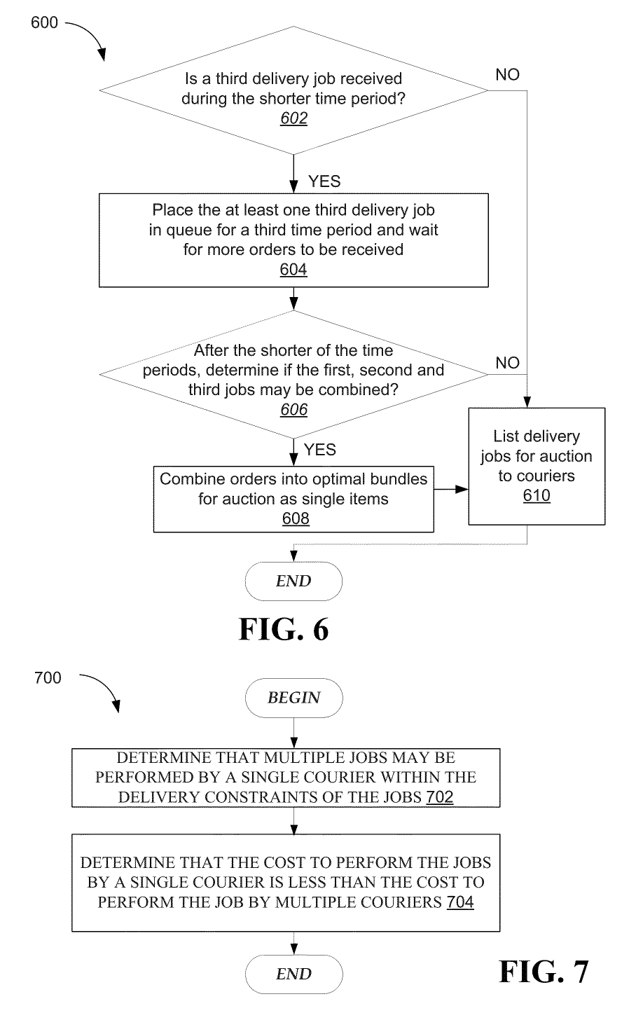

FIG. 6 shows a flow diagram illustrating one example embodiment of a method 600 for further optimal bundling of routes in a courier marketplace.

At operation 602, if a third job is not received before the shorter of the first and second time periods has expired then the job in the queue with the associated shortest time period may be listed for auction alone or in combination with the other at operation 610. If a third job is received before the shorter of the time periods has expired, the third job may also be placed into the queue for a third period of time based on the details of the third job at operation 604.

After the shortest of the first, second, and third time periods has expired, at operation 606, it is determined if any of the jobs may be combined such that a single courier may deliver multiple packages cost effectively without violating any of the constraints included in the details of each delivery job associated with said multiple packages. If not, then the job with the associated time period that is the shortest may be listed for auction to couriers immediately, and the other jobs may remain in the queue for the remainder of their associated time periods at operation 610.

If it is determined that two or more of the jobs may be combined so that a single courier may deliver multiple packages without violating any of the constraints included in the details of each delivery job associated with said multiple packages, then the jobs are bundled for auction as a single item at operation 608, and listed for auction to couriers at operation 610.

FIG. 7 shows a flow diagram illustrating one example embodiment of a method 700 for determining a cost of traveling different delivery routes for couriers.

At operation 702, it is determined that multiple jobs in the queue may be combined for delivery of the associated packages cost effectively by a single courier without violating any of the associated delivery constraints of the jobs.

At operation 704, it is then determined whether the cost of delivering the multiple packages by a single courier is less than the cost to deliver the same packages by multiple couriers. As explained above, this determination may be based on the distances traveled by each courier, the time it takes for a courier to traverse the route, or the numbers of stops for each courier or other relevant data.

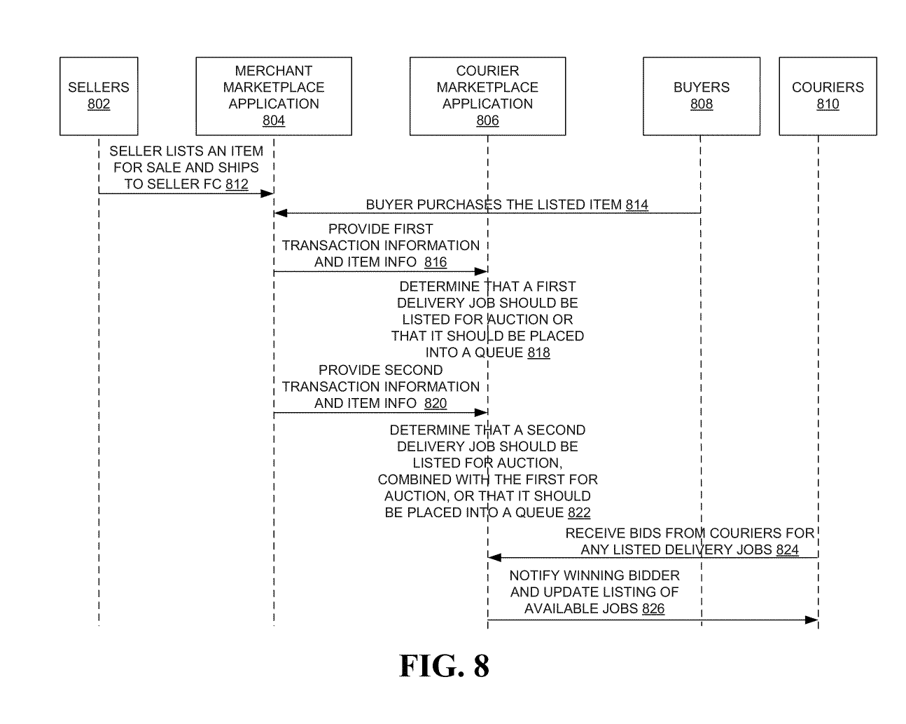

FIG. 8 shows a ladder diagram illustrating one example embodiment of an operation of a courier marketplace application 122.

A seller, from among sellers 802 lists an item for sale via the marketplace application 120 and ships the item to a corresponding seller warehouse (fulfillment center) at operation 812.

A buyer, from among buyers 808 purchases the listed item at operation 814.

At operation 816, the courier marketplace application 122 communicates with the marketplace application 804 to obtain first purchase transaction details.

At operation 818, the courier marketplace application 806 determines whether the first delivery job (to deliver the purchased item) should be auctioned to couriers immediately or placed in a queue based on the delivery constraints associated with the first job.

At operation 820, the courier marketplace application 806 communicates with the marketplace application 804 to obtain second purchase transaction details regarding a seller from sellers 802 and buyer from buyers 808. The second purchase transaction may include all, some or none of the participants (e.g., buyer and seller) of the first transaction.

At operation 822, the courier marketplace application 806 determines whether the second delivery job should be auctioned to couriers immediately or placed in a queue based on the delivery constraints associated with the first job. At operation 822, the courier marketplace application 806 also determines whether the second delivery job may be combined with the first job for delivery of both items by a single courier without violating any of the delivery constraints associated with the first and second jobs.

At operation 824, the courier marketplace application 806 may receive bids from couriers 810 for any jobs or bundles of jobs that have been listed for auction after the respective time periods have expired.

At operation 826, the courier marketplace application 806 notifies any winning bidders and updates the listing of jobs available for couriers 810 to bid on after each auction.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

### Example Computer System

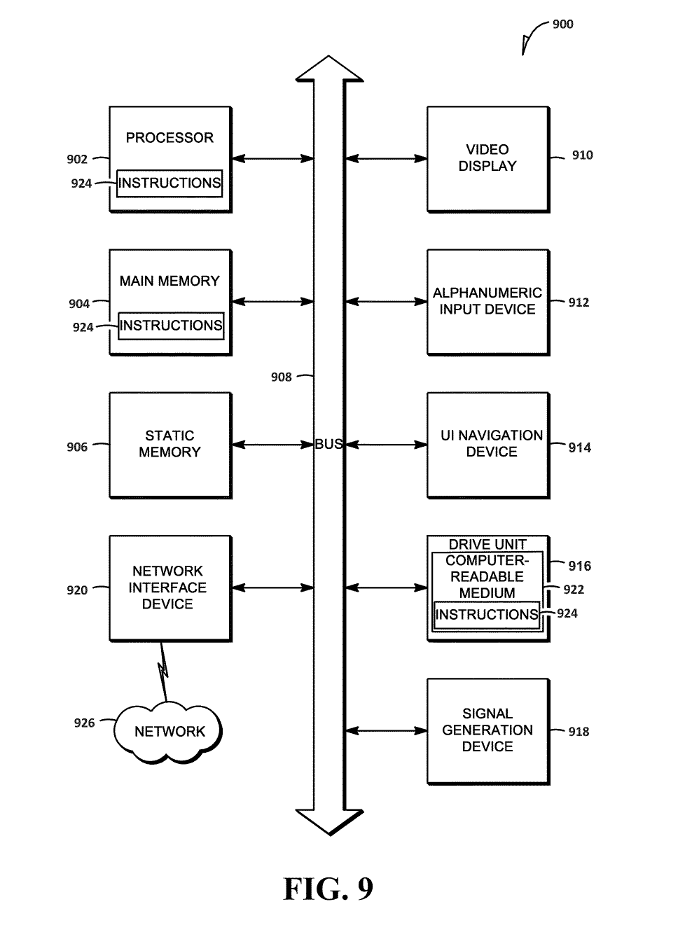

FIG. 9 shows a diagrammatic representation of a machine in the example form of a computer system 900 within which a set of instructions 924 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 924 (sequential or otherwise) that specify actions to be taken by that machine. Further, while only a single machine is illustrated, the term “machine” shall also be taken to include any collection of machines that individually or jointly execute a set (or multiple sets) of instructions 924 to perform any one or more of the methodologies discussed herein.

The example computer system 900 includes a processor 902 (e.g., a central processing unit (CPU), a graphics processing unit (GPU, or both)), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a UI navigation device 914 (e.g., a mouse), a drive unit 916, a signal generation device 918 (e.g., a speaker), and a network interface device 920.

The drive unit 916 includes a computer-readable medium 922 on which is stored one or more sets of data structures and instructions 924 (e.g., software) embodying or utilized by any one or more of the methodologies or functions described herein. The instructions 924 may also reside, completely or at least partially, within the main memory 904 or within the processor 902 during execution thereof by the computer system 900, with the main memory 904 and the processor 902 also constituting machine-readable media.

The instructions 924 may further be transmitted or received over a network 926 via the network interface device 920 utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

While the computer-readable medium 922 is shown in an example embodiment to be a single medium, the term “computer-readable medium” should be taken to include a single medium or multiple media (e.g., a centralized or distributed database, and/or associated caches and servers) that store the one or more sets of instructions 924. The term “computer-readable medium” shall also be taken to include any medium that is capable of storing, encoding, or carrying a set of instructions 924 for execution by the machine and that cause the machine to perform any one or more of the methodologies of the present disclosure, or that is capable of storing, encoding or carrying data structures utilized by or associated with such a set of instructions 924. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

Although an overview of the inventive subject matter has been described with reference to specific example embodiments, various modifications and changes may be made to these embodiments without departing from the broader scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
receiving a first job for delivery of a first package from a first pickup location to a first drop-off location, the first job including first delivery constraints;
placing the first job into a queue for a first period of time that is determined based on the first delivery constraints, expiration of the first period of time causing the first job to be listed on an online marketplace for auction to couriers;
receiving a second job before the first period of time expires, the second job being for delivery of a second package from a second pickup location to a second drop-off location, the second job including second delivery constraints;
based on determining that the first job and the second job cannot be performed cost effectively by a single courier within the delivery constraints of both jobs, placing the second job into the queue for a second period of time that is determined based on the second delivery constraints, expiration of the second period of time causing the second job to be listed on the online marketplace for auction to the couriers; and
based on determining that the first and second jobs can be performed cost effectively by a single courier within the delivery constraints of both the first and second jobs, listing the first and second jobs as a single item on the online marketplace for auction to couriers in response to expiration of a third period of time that is determined based on the delivery constraints of both the first and second jobs.

2. The method of claim 1, wherein the determining that the first and second job can be performed cost effectively by a single courier includes determining that the first and second packages can be delivered along a single route at less cost than the first and second packages being delivered along respective first and second routes.

3. The method of claim 2, wherein the cost of a route is measured as a function of a distance a courier travels to traverse the route or as a function of a time it takes for the courier to traverse the route.

4. The method of claim 2, wherein the cost of a route is measured as a function of a number of distinct pickup locations and a number of distinct drop-off locations along the route.

5. The method of claim 1, further comprising:
receiving a third job for delivery before the third period of time expires, the third job being for delivery of a third package from a third pickup location to a third drop-off location, the third job including third delivery constraints;
based on determining that the third job cannot be performed together with at least one of the first or second jobs cost effectively by the single courier within the delivery constraints of the jobs to be performed together, placing the third job into the queue for a fourth period of time that is determined based on the third delivery constraints, expiration of the fourth period of time causing the third job to be listed on the online marketplace for auction to the couriers;
based on determining that the third job can be performed together with at least one of the first or second jobs cost effectively by a single courier within the respective delivery constraints of the jobs to be performed together, creating one or more bundles of jobs that result in a lowest combined cost of routes for delivery of the first, second, and third packages within the respective delivery constraints of the jobs; and
based on determining that a particular bundle can be performed cost effectively by the single courier within the respective delivery constraints of the jobs in the particular bundle, listing the particular bundle on the online marketplace for auction to the couriers in response to expiration of a fifth period of time that is determined based on the delivery constraints of the jobs in the particular bundle.

6. The method of claim 5, further comprising:
based on determining that no new job for delivery of an additional package is likely to be received before the fifth period of time expires, wherein the new job may be performed together with the jobs of the particular bundle cost effectively by a single courier within the respective delivery constraints of the jobs to be performed together, listing the particular bundle on the online marketplace for auction to the couriers.

7. The method of claim 6, wherein the determining that no new job for delivery of the additional package that may be performed together with the jobs of the particular bundle is likely to be received includes processing historical data regarding at least one of: a rate at which jobs are received, or a likelihood of receiving a job with an associated pickup or drop-off location that is within a threshold distance limit from any of the pickup or drop-off locations associated with other jobs in the queue before each of their respective associated time periods expire.

8. A system comprising:
an online courier marketplace including at least one processor and configured to:
receive a first job for delivery of a first package from a first pickup location to a first drop-off location, the first job including first delivery constraints;
place the first job into a queue for a first period of time that is determined based on the first delivery constraints, expiration of the first period of time causing the first job to be listed for auction to couriers;
receive a second job before the first period of time expires, the second job being for delivery of a second package from a second pickup location to a second drop-off location, the second job including second delivery constraints;
based on determining that the first and second jobs cannot be performed cost effectively by a single courier within the delivery constraints of both jobs, place the second job into the queue for a second period of time that is determined based on the second delivery constraints, expiration of the second period of time causing the second job to be listed for auction to the couriers; and
based on determining that the first and second jobs can be performed cost effectively by a single courier within the delivery constraints of both jobs, list the first and second jobs as a single item on the online marketplace for auction to the couriers in response to expiration of a third period of time that is determined based on the delivery constraints of both the first and second jobs.

9. The system of claim 8, wherein the determining that the first and second job can be performed cost effectively by the single courier includes determining that the first and second packages can be delivered along a single route at less cost than the first and second packages being delivered along a respective first route and a second route.

10. The system of claim 9, wherein the cost of a route is measured as a function of a distance a courier travels to traverse the route or as a function of a time it takes for the courier to traverse the route.

11. The system of claim 9, wherein the cost of a route is measured as a function of a number of distinct pickup locations and a number of distinct drop-off locations along the route.

12. The system of claim 11, wherein the online courier marketplace is further configured to:
receive a third job for delivery before the third period of time expires, the third job being for delivery of a third package from a third pickup location to a third drop-off location, the third job including third delivery constraints;
based on determining that the third job cannot be performed together with at least one of the first or second jobs cost effectively by the single courier within the delivery constraints of the jobs to be performed together, place the third job into the queue for a fourth period of time that is determined based on the third delivery constraints, expiration of the fourth period of time causing the third job to be listed on the online marketplace for auction to the couriers;
based on determining that the third job can be performed together with at least one of the first or second jobs cost effectively by a single courier within the respective delivery constraints of the jobs to be performed together, create one or more bundles of jobs that result in a lowest combined cost of routes for delivery of the first, second, and third packages within the respective delivery constraints of the jobs; and
based on determining that a particular bundle can be performed cost effectively by the single courier within the respective delivery constraints of the jobs in the particular bundle, list the particular bundle on the online marketplace for auction to the couriers in response to expiration of a fifth period of time that is determined based on the delivery constraints of the jobs in the particular bundle.

13. The system of claim 12, wherein the online courier marketplace is further configured to:
list the particular bundle on the online marketplace for auction to couriers based on determining that no new job for delivery of an additional package is likely to be received before the fifth period of time expires, wherein the new job may be performed together with the jobs of the particular bundle cost effectively by a single courier within the respective delivery constraints of the jobs to be performed together.

14. The system of claim 13, wherein the determining that no new job for delivery of the additional package that may be performed together with the jobs of the particular bundle is likely to be received includes processing historical data regarding at least one of: a rate at which jobs are received, or a likelihood of receiving a job with an associated pickup or drop-off location that is within a threshold distance limit from any of the pickup or drop-off locations associated with other jobs in the queue before each of their respective associated time periods expire.

15. A non-transitory computer-readable storage medium storing a set of instructions that, when executed by a processor of a machine, cause the machine to perform operations comprising:
receiving a first job for delivery of a first package from a first pickup location to a first drop-off location, the first job including first delivery constraints;
placing the first job into a queue for a first period of time that is determined based on the first delivery constraints, expiration of the first period of time causing the first job to be listed on an online marketplace for auction to couriers;
receiving a second job before the first period of time expires, the second job being for delivery of a second package from a second pickup location to a second drop-off location, the second job including second delivery constraints;
based on determining that the first job and the second job cannot be performed cost effectively by a single courier within the delivery constraints of both jobs, placing the second job into the queue for a second period of time that is determined based on the second delivery constraints, expiration of the second period of time causing the second job to be listed on the online marketplace for auction to the couriers; and
based on determining that the first and second jobs can be performed cost effectively by a single courier within the delivery constraints of both the first and second jobs, listing the first and second jobs as a single item on the online marketplace for auction to couriers in response to expiration of a third period of time that is determined based on the delivery constraints of both the first and second jobs.

16. The computer-readable storage medium of claim 15, wherein the determining that the first and second job can be performed cost effectively by a single courier includes determining that the first and second packages can be delivered along a single route at less cost than the first and second packages being delivered along respective first and second routes.

17. The computer-readable storage medium of claim 16, wherein the cost of a route is measured as a function of a distance a courier travels to traverse the route or as a function of a time it takes for the courier to traverse the route.

18. The computer-readable storage medium of claim 17, the operations further comprising:
receiving a third job for delivery before the third period of time expires, the third job being for delivery of a third package from a third pickup location to a third drop-off location, the third job including third delivery constraints;
based on determining that the third job cannot be performed together with at least one of the first or second jobs cost effectively by the single courier within the delivery constraints of the jobs to be performed together, placing the third job into the queue for a fourth period of time that is determined based on the third delivery constraints, expiration of the fourth period of time causing the third job to be listed on the online marketplace for auction to the couriers;
based on determining that the third job can be performed together with at least one of the first or second jobs cost effectively by a single courier within the respective delivery constraints of the jobs to be performed together, creating one or more bundles of jobs that result in a lowest combined cost of routes for delivery of the first, second, and third packages within the respective delivery constraints of the jobs; and
based on determining that a particular bundle can be performed cost effectively by the single courier within the respective delivery constraints of the jobs in the particular bundle, listing the particular bundle on the online marketplace for auction to the couriers in response to expiration of a fifth period of time that is determined based on the delivery constraints of the jobs in the particular bundle.

19. The computer-readable storage medium of claim 15, the operations further comprising:
listing the particular bundle on the online marketplace for auction to couriers based on determining that no new job for delivery of an additional package is likely to be received before the fifth period of time expires, wherein the new job may be performed together with the jobs of the particular bundle cost effectively by a single courier within the respective delivery constraints of the jobs to be performed together.

20. The computer-readable storage medium of claim 19, wherein the determining that no new job for delivery of the additional package that may be performed together with the jobs of the particular bundle is likely to be received includes processing historical data regarding at least one of: a rate at which jobs are received, or a likelihood of receiving a job with an associated pickup or drop-off location that is within a threshold distance limit from any of the pickup or drop-off locations associated with other jobs in the queue before each of their respective associated time periods expire.
